(19) United States
(12) Patent Application Publication
(10) Pub. No.: US 2005/0278993 A1
(43) Pub. Date: Dec. 22, 2005

(54) Multiple business card holder

(76) Inventors: Mary Beth Boyette, Wetumpka, AL (US); Jeff Clyde Tate, Deatsville, AL (US); Cynthia Shepherd Tate, Deatsville, AL (US)

Correspondence Address: MARY BETH BOYETTE, 174 EAST DEER TRACK DRIVE, WETUMPKA, AL, 36093, US

(21) Appl. No.: 11/133,951

(22) Filed: May 20, 2005

Related U.S. Application Data
(60) Provisional application No. 60/580,317, filed on Jun. 17, 2004.

(51) Int. Cl. G09F 1/10; G09F 3/18

(52) U.S. Cl. 40/124.2; 40/124

(57) ABSTRACT

A Multiple Business Card Holder includes a plurality of support walls nailed together forming a framed apparatus. Horizontal and vertical dividers are used for separating interior space of said apparatus whereby multiple compartments are contained within one body. Said compartments are of significant size for displaying a set of business cards in stacked position, laying flat, with back side of said cards facing downward, providing an unobstructed view for information contained on front of said card.

Applicant claims benefit of the Provisional Application No. 60/580,317. Filing date Jun. 17, 2004.

### References Cited:

| | | |
|---|---|---|
| 965019 | 1910 | Schandein |
| D135871 | 1943 | Ferrier |
| D190178 | 1961 | Goodyear |
| D232887 | 1974 | Funahashi |
| D255300 | 1980 | Charles |
| D307993 | 1990 | Cignarella |
| D322728 | 1991 | Berman |
| D319666 | 1991 | Kheng |
| D317178 | 1991 | Kheng |
| D325313 | 1992 | Evenson |
| D324883 | 1992 | Demirjiam |
| D332630 | 1993 | Brussing |
| D3377617 | 1993 | Hall Jr. |
| D355555 | 1995 | Ryan |
| D381362 | 1997 | Meyer |
| D380496 | 1997 | Meyer |
| D378533 | 1997 | Wolff |
| 5823353 | 1998 | Perri |
| D471008 | 2003 | Dubone |

### BACKGROUND OF INVENTION

1. Field of Invention

This invention is directly related to business card holders and the position in which the business cards are displayed within.

2. Discription of Prior Art

U.S. Pat. No. D381362 displays multiple sets of business cards slightly out of a vertical position. Compartments are in rows with bottom support horizontal. Front support hides portion of business card. Business cards contained within a compartment of this invention has to be extracted whereby one can read vital information.

U.S. Pat. No. D324883. Business cards contained within compartments are vertical. Bottom support, in each compartment, is horizontal. Front support obstructs view of information printed on a business card contained within. This invention attaches to a wall or vertical surface. In many cases, an individual will have to move away from the communication area to retrieve information desired.

U S. Pat. No. D380496. Business cards contained within each compartment are vertical. Cards are secured by corner supports. This invention attaches to a wall or vertical surface.

U.S. Pat. No. D378533. A storage bin type apparatus with moveable dividers for containing a plurality of items of different size.

U.S. Pat. No. D471008. A flexible cardholder of sufficient size for individuals pocket. This invention holds two sets of business cards.

U.S. Pat. No. 5,823,353. This invention is for an individual set of business cards. There is a hinge whereby said cardholder converts to desktop display holding said cards slightly out of vertical position.

U.S. Pat. No. D337617. This invention displays a plurality of individual s' business cards. An elongated back support provides stability for vertical compartments. Front support of each compartment obstructs view of information on business card contained within

U.S. Pat. No. 319,666. Bottom support is horizontal. Back support is slightly angled. A set of business cards leans back in an upright position.

### SUMMARY

Traditionally, a set of business cards are displayed, by most business card holders, in a vertical or slightly angled, up right position. The front support wall of many business card holders obstructs the view of information contained on the front of said card. Said business cardholders with these characteristics do not protect said cards form the wear and tier of a single card being extracted many times over. Said cards are frayed on the edges and corners. They become unsightly to present to potential customers. There are many times when the front desk, reception or check out area has many separate business cardholders scattered, and loose. This creates an unorganized appearance.

The Multiple Business Card Holder displays a mutitude of individuals' business cards within one body. Said cards are displayed, within each compartment, in stacked position, lying flat, with backside facing downward. Bottom support of said cardholder is elevated in back thereby creating an angle. Said angle, allows a set of business cards to be displayed with the benefit of comfortable reading and easy extraction of a single card without damaging other cards within that compartment. Information on front of said cards is displayed with out obstruction to the front information on said cards. Further objects and advantages will become apparent from the ensuing description.

### DISCRIPTION OF DRAWINGS

FIG. 1. Shows a front view of the Multiple Business Card Holder. Support system consist of, a back wall 22, a front wall 24, a left outer most side wall 26, a right outer most side wall 28. A horizontal means 30 and a vertical means 32, used for dividing interior space within said cardholder. Are attached and joined to support walls providing a plurality of compartments 34.

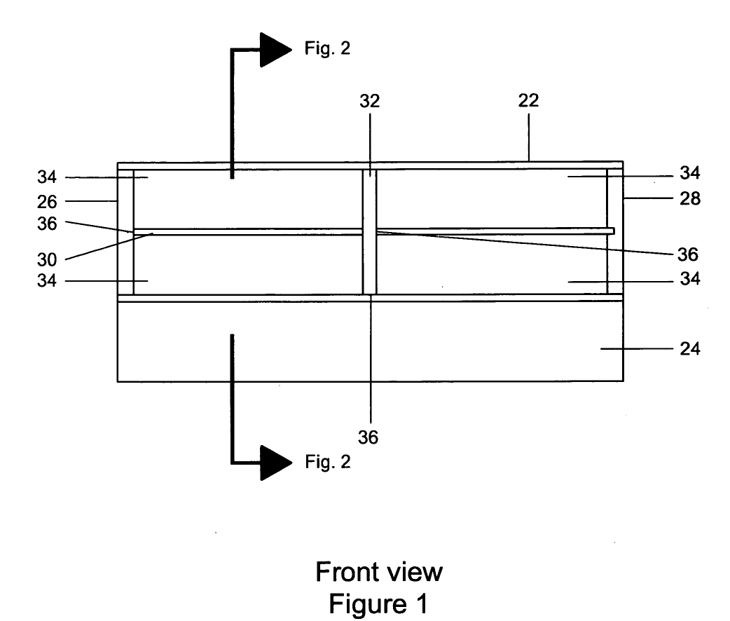

FIG. 2. Shows a cross section view of said cardholder. Back wall 22, front wall 24, bottom support 20, and placement of means 36, used for attachment, shows elevation of said bottom support 20, providing easy reading and extraction of said cards contained within.

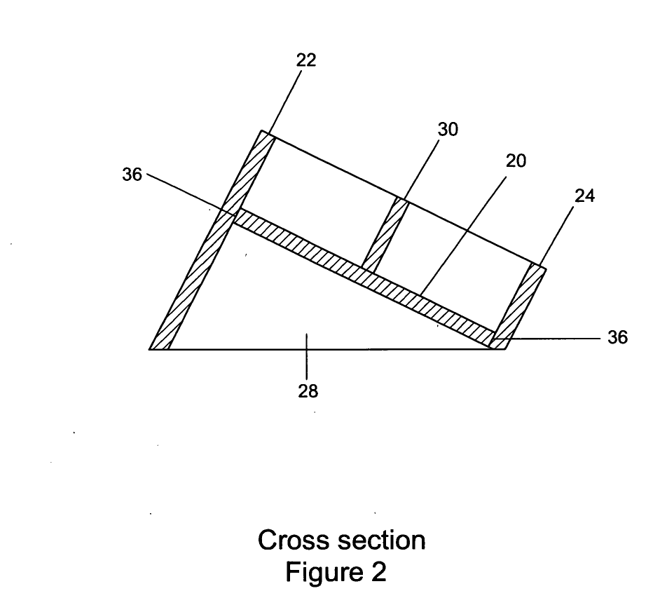

FIG. 3. Shows left side view of said cardholder. Shown is elevation of bottom support sufficient for displaying business cards in stacked position, lying flat, with backside facing downward. Back wall 22, front wall 24 left outer most wall 26. If desired notches 40 are also shown.

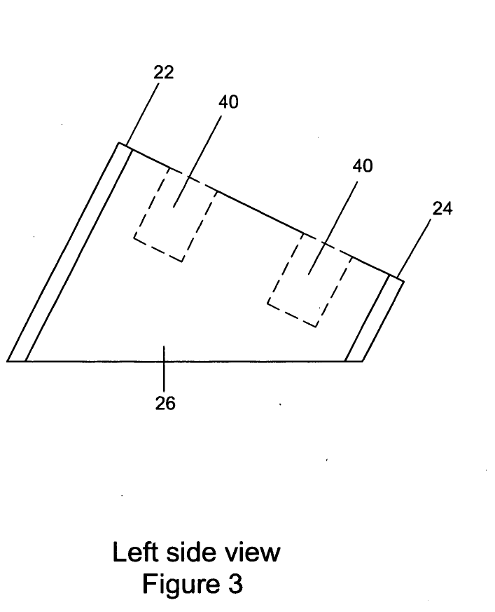

FIG. 4. Shows right side view of said cardholder. Shown is the elevation of bottom support sufficient for displaying business cards in stacked position, lying flat, with backside facing downward. Back wall 22, front wall 24, right outer most wall 26. If desired notches 40 are also shown.

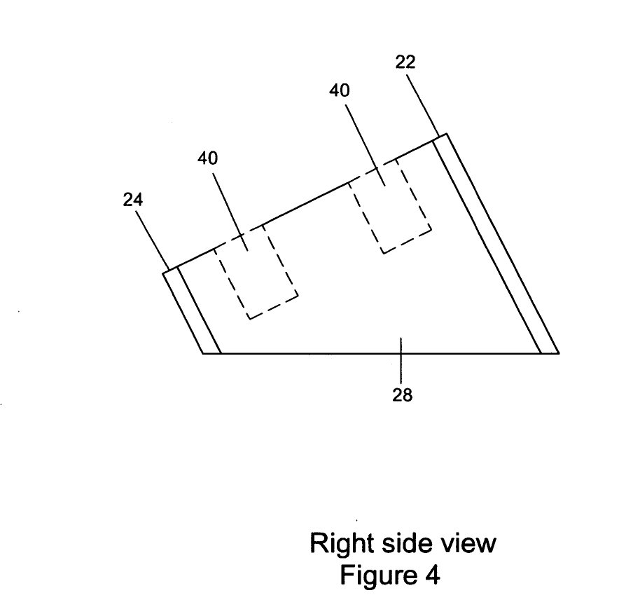

FIG. 5. Shows top view of said cardholder. Depth of said compartments 34 are sufficient for containing a large number of said cards in stacked position, with backside facing downward. Back wall 22, front wall 24, left outer most wall 26, and right outer most wall 28, forms a framed apparatus. Horizontal 30 and vertical 32 means used for dividing space within said cardholder provides a support system for independent compartments 34.

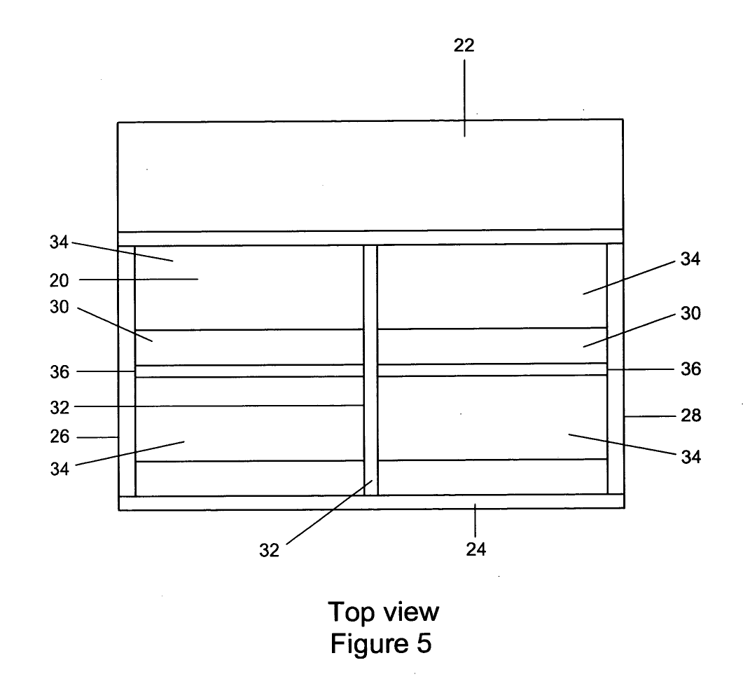

### A DETAILED DISCRIPTION

A ridged material is used to make the elements, that comprise the Multiple Business Card Holder. Said elements consist of, a bottom support 20, a back support 22, a front support 24, a left outer most wall 26, and a right outer most wall 28. Said elements are of sufficient size, predetermined by the number of compartments 34 to be contained within said cardholder. Said bottom support 20 is joined to said back wall 22 by a first means, used for attachment. Placement of said means depends on predetermined depth of said compartments 34. Said means used for attachment of said bottom support to base portion of said front wall 24. Said back wall 22 is significantly taller than said front wall 24, whereby after attachment said bottom support 20 is sufficiently elevated in back than front, providing an angle. Said left outer most wall 26 is joined to said bottom support, to said back wall 22, and to said front wall 24 by means used for attachment. Said right outer most wall 28 is joined to said bottom support 20, to said back wall 22, and to said front wall 24 by means used for attachment. The upper portion of said left 26 and said right 28 outer most walls are angled. Said angle is sufficient for attachment of said outer most left 26 and right 28 walls to match the height of said back wall 22 and match the substantially shorter said front wall 24 height. Placement of said means joining said left outer wall 26 and said right 28 outer most walls to said bottom support 20 depend on predetermined depth of said compartments 34 contained within. A horizontal means 30 is used for dividing space within said cardholder. Said means used for attachment, joins said horizontal 30 dividers to said left 26 and said right 28 outer most walls. A vertical means 32 is used for dividing space within said cardholder. Said means joins said vertical 32 dividers to said back wall 22 and said front wall 24. The number of said horizontal 30 and said vertical 32 dividers used within said cardholder is predetermined by the number of said compartments 34 to be contained. Said horizontal means 30 and said vertical means 32 used for dividing space allow said cardholder to contain a plurality of compartments 34. Said compartments 34 are of significant size for easy extraction of said cards. Size of said compartments 34 allows a large number of said cards to be contained in each set.

A single compartment 34 can be comprised for individual use. Elements used are the same as above description, which make up said compartments 34. As in description above, said bottom support 20 allows said cards to lay flat slightly, elevated in back, for easy reading. Notches can be taken out of walls that surround said compartments as in drawings. Notches are of sufficient size for ones finger to easily slip in and out of said compartments 34, when retrieving a single card.

A ridged material used to comprise said cardholder can be of wood, plastic, Plexiglas, and the like. If made of wood, said cardholder can be painted, polyurathained, or left natural. Means of attachment can be grooves, Velcro, glue, nails, and the like. In any ridged material said cardholder is practical and economical to manufacture. A mold can be comprised providing economical production of said cardholder.

1. A Multiple Business CardHolder for displaying many sets of business cards in staked positions comprising;
a) a set of support walls made from a ridged material are joined, one to another, by a means used for attachment forming a framed apparatus whereby;
b) a horizontal and vertical means for dividing space within one body wherein;
c) a plurality of compartments of significant size for said cards, to lay flat, with backside facing downward.

2. As in claim 1, a framed apparatus made of wood includes a back wall, a front wall, a left outer most side wall, and a right outer most side wall joined together by nails used for attachment to a common bottom support wherein,
said bottom support is joined to said back wall with an elevation at back of said bottom support.

3. As in claim 2, said front wall is significantly shorter than said back wall whereby;
said bottom support is attached to back base of said front wall creating an angle sufficient for an elevation within said compartments.

4. As in claim 2, said left outer most side wall is significantly taller in back than front whereby;
when joined by nails to said bottom support, to said back wall, and to said front wall, a flow of elevation from back to front within said cardholder is provided.

5. As in claim 2 said right outer most side wall is significantly taller in back than front whereby;
when joined by nails to said bottom support, to said back wall, and to said front wall, a flow of elevation from back to front within said cardholder is provided.

6. As in claim 1, a horizontal divider is of three-eighth stock, joined to said left outer most wall and to said right outer most wall wherein;
separation of interior space is provided within said cardholder.

7. As in claim 1, a vertical divider is of three-eighth stock joined to said back wall and to said front wall wherein;
separation of interior space is provided within said cardholder.

8. As in claim 1, said compartments are one-half inch greater in circumference than a standard size business card wherein;
a single card can be extracted without damage to remaining cards in said compartment.

9. As in claim 1, said compartments are elevated from back to front.

10. As in claim 1, said compartments are of significant depth within;
a great number of said cards can be contained in each stack.
